(19) United States
(12) Patent Application Publication
(10) Pub. No.: US 2025/0180813 A1
(43) Pub. Date: Jun. 5, 2025

(54) FIBER OPTIC DISTRIBUTION ARCHITECTURE AND RELATED FIBER OPTIC COMPONENTS

(71) Applicant: CommScope Technologies LLC, Hickory, NC (US)

(72) Inventors: Thomas A. THIGPEN, Highland Village, TX (US); Thomas G. LEBLANC, Westminster, MA (US); Thomas PARSONS, Leominster, MA (US)

(21) Appl. No.: 18/964,027

(22) Filed: Nov. 29, 2024

Related U.S. Application Data
(60) Provisional application No. 63/604,434, filed on Nov. 30, 2023.
(60) Provisional application No. 63/552,554, filed on Feb. 12, 2024.
(60) Provisional application No. 63/575,250, filed on Apr. 5, 2024.

(51) Int. Cl. G02B 6/28

(52) U.S. Cl. CPC G02B 6/2804

(57) ABSTRACT

The present disclosure relates to a fiber optic distribution architecture for an optical network that uses a relatively low fiber count cable and implements passive optical power splitting at or near an edge of the network. Optical components for building/deploying the architecture are also disclosed.

### CROSS-REFERENCE TO RELATED APPLICATION

The present application claims the benefit of U.S. Provisional Patent Application No. 63/604,434, filed Nov. 30, 2023, U.S. Provisional Patent Application No. 63/552,554, filed Feb. 12, 2024, and U.S. Provisional Patent Application No. 63/575,250, filed Apr. 5, 2024, the disclosures of which are hereby incorporated by reference herein in their entirety.

### TECHNICAL FIELD

The present disclosure relates to fiber optic data transmission, and more particularly to fiber optic distribution systems and architectures.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. With regard to fiber optic communication systems, there is a need for distribution architectures that reduce cost particularly for rural deployments.

### SUMMARY

Aspects of the present disclosure relate to fiber optic distribution architectures that reduce cost and are easy to deploy. Certain aspects of the present disclosure relate to fiber optic architectures particularly well suited for deployment in lower density environments such as rural environments where subscribers are more spread out than urban environments. Certain aspects of the present disclosure relate to fiber optic architectures that move passive optical power splitting out toward the edge of the network (e.g., out to the “last mile”), maximize cable fiber re-use and utilize relatively small fiber count fiber optic cables.

One aspect of the present disclosure relates to a fiber optic architecture including a fiber optic cable including a first group of optical fibers including feed fibers and a second group of optical fiber including distribution fibers. The architecture also includes a plurality of passive optical power splitters spaced-apart along a length of the fiber optic cable and positioned at first mid-span locations of the fiber optic cable. The feed fibers are optically coupled to inputs of the passive optical power splitters. The distribution fibers are divided into pairs of upstream and downstream fiber segments with each pair of upstream and downstream fiber segments being optically coupled to an output of one of the passive optical power splitters. The upstream fiber segments extend through the fiber optic cable in an upstream direction from their corresponding passive optical splitters and the downstream fiber segments extend through the fiber optic cable in a downstream direction from their corresponding passive optical power splitters. The architecture also includes subscriber access locations positioned at second mid-span locations of the fiber optic cable spaced along the upstream and downstream fiber segments for allowing subscribers to be optically connected to the upstream and downstream fiber segments and thus optically connected to the fiber optic architecture.

Aspects of the present disclosure also relate to optical components that can be used to efficiently build network architectures in accordance with the principles of the present disclosure. One example optical component includes a housing; a passive optical power splitter positioned within the housing, the passive optical power splitter including an optical input and a plurality of optical outputs optically coupled to the input; and a first stub fiber optic cable that extends outwardly from the housing, the first stub fiber optic cable including a feed optical fiber and a plurality of distribution optical fibers, the feed optical fiber being optically coupled to the optical input of the passive optical power splitter and the distribution optical fibers being optically coupled to the plurality of optical outputs of the passive optical power splitter.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 is a schematic view of an example fiber optic network deployment having a fiber optic distribution architecture in accordance with the principles of the present disclosure;

FIG. 2 is a more detailed schematic view of a portion of the deployment of FIG. 1;

FIG. 3 depicts a fiber optic component in accordance with the principles of the present disclosure suitable for use in implementing a fiber optic architecture in accordance with the principles of the present disclosure;

FIG. 4 is a transverse cross-section view of a fiber optic cable suitable for use as stub fiber optic cables of the fiber optic component of FIG. 3;

FIG. 5 depicts a network architecture in accordance with the principles of the present disclosure using the fiber optic component of FIG. 3; wherein a plurality of optical components each configured as the fiber optic component of FIG. 3 are daisy-chained together to form the network architecture;

FIG. 6 depicts a fiber routing an coupling diagram for the fiber optic component of FIG. 3;

FIG. 7 is a transverse cross-section view of another fiber optic cable suitable for use as stub fiber optic cables of the fiber optic component of FIG. 3;

FIG. 8 depicts a network architecture in accordance with the principles of the present disclosure using a chain of fiber optic components configured as the component of FIG. 3 with stub cables having the cable configuration of FIG. 7;

FIG. 9 depicts another fiber optic component in accordance with the principles of the present disclosure suitable for use in implementing a fiber optic architecture in accordance with the principles of the present disclosure;

FIG. 10 is another schematic depiction of the fiber optic component of FIG. 9; and

FIG. 11 depicts a network architecture in accordance with the principles of the present disclosure using a chain of fiber optic components configured as the component of FIGS. 9 and 10;

FIG. 12 depicts a plug-and-play network architecture in accordance with the principles of the present disclosure including an assembly using a fiber optic cable with factory installed break-out locations;

FIG. 13 is an enlarged view of a portion of the assembly of FIG. 12;

FIG. 14 depicts the portion of the assembly of FIG. 13 connected to hub and distribution terminals by plug-and-play connections provided by connectorized tethers located at the break-out locations;

FIG. 15 schematically depicts an example hub terminal suitable for use with the architecture of FIG. 12;

FIG. 16 schematically depicts an example distribution terminal suitable for use with the architecture of FIG. 12;

FIG. 17 schematically depicts an example configuration for a hub break-out location suitable for use with the architecture of FIG. 12;

FIG. 18 schematically depicts an example configuration for an upstream subscriber access break-out location suitable for use with the architecture of FIG. 12; and

FIG. 19 schematically depicts an example configuration for a downstream subscriber access break-out location suitable for use with the architecture of FIG. 12.

### DETAILED DESCRIPTION

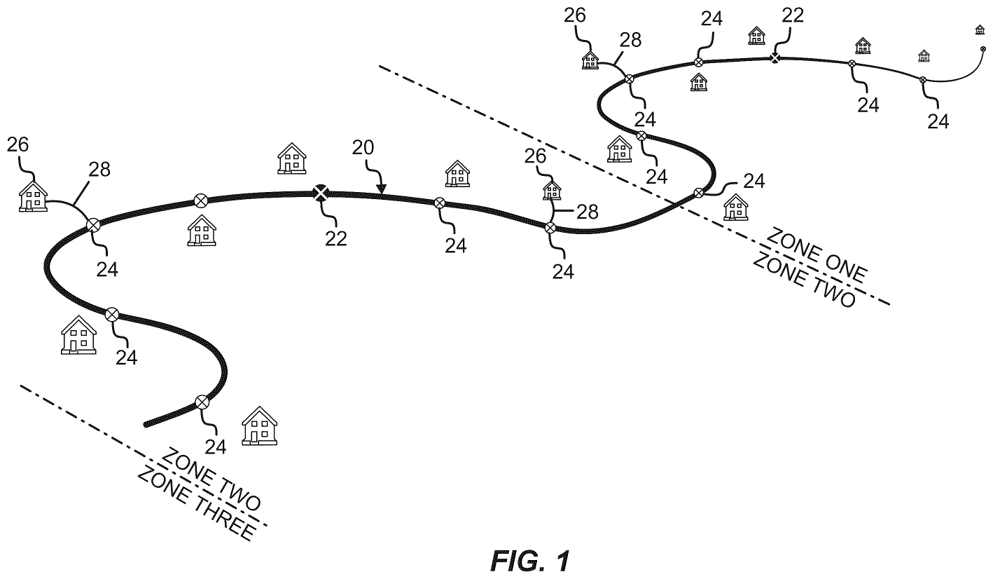

FIG. 1 is a schematic view of an example fiber optic network deployment having a fiber optic distribution architecture in accordance with the principles of the present disclosure. The fiber optic architecture includes a fiber optic cable 20 and plurality of fiber distribution hubs 22 spaced along a length of the fiber optic cable and positioned at first midspan locations of the fiber optic cable 20. The fiber optic architecture also includes subscriber access locations 24 positioned at second midspan locations of the fiber optic cable 20. Subscribers 26 can be optically connected to the network by cables 28 (e.g., drop cables) that connect to the network at the subscriber access locations 24.

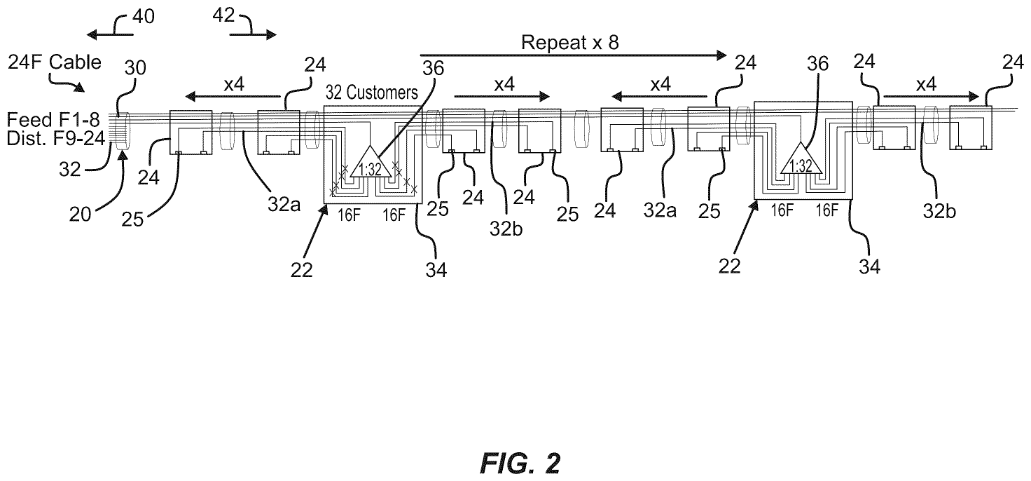

FIG. 2 is a more detailed schematic view of a portion of the deployment of FIG. 1. As depicted, the fiber optic cable 20 includes a first group of optical fibers including feed fibers 30 and a second group of optical fiber including distribution fibers 32. The feed fibers 30 can be dedicated feed fibers each fed from a separate port of an Optical Line Terminal. The distribution fibers 32 can be designated/dedicated for use in distributing optical service to the subscribers 26 and can be divided into separate fiber distribution segments within the fiber optic cable 20 with the different segments corresponding to and providing service to different zones of the network.

As depicted, the fiber distribution hubs 22 include environmentally sealed enclosures 34 (e.g., housings that can in some examples be re-enterable) through which the cable 20 is routed. The fiber distribution hubs 22 include passive optical power splitters 36 mounted within the enclosures 34. The fiber distribution hubs 22 and their corresponding passive optical power splitters 36 are spaced-apart along a length of the fiber optic cable 22 and positioned at first mid-span locations of the fiber optic cable 22. As shown at FIG. 2, the feed fibers 30 are optically coupled to inputs of the passive optical power splitters 36. The distribution fibers 32 are divided into pairs of upstream and downstream fiber segments 32a, 32b with each pair of upstream and downstream fiber segments 32a, 32b being optically coupled to an output of one of the passive optical power splitters 36. Each optical power splitter 36 and its corresponding pair of upstream and downstream fiber segments 32a, 32b service a different subscriber zone of the network architecture. The upstream fiber segments 32a extend through the fiber optic cable 20 in an upstream direction 40 from their corresponding passive optical splitters 36 and the downstream fiber segments extend through the fiber optic cable 20 in a downstream direction 42 from their corresponding passive optical splitters 36. The subscriber access locations 24 are positioned at second mid-span locations of the fiber optic cable 22 spaced along the upstream and downstream fiber segments 32a, 32b for allowing the subscribers 26 to be optically connected to the upstream and downstream fiber segments 32a, 32b and thus optically connected to network fiber optic architecture.

In one example, the fiber optic cable 20 includes only twenty-four fibers (e.g., eight feed fibers and sixteen distribution fibers) and the passive optical power splitters 36 are 1by 32 splitters with sixteen splitter outputs connected to the upstream fiber segments 32a and sixteen splitter outputs connected to the downstream fiber segments 32b. The splitter outputs can be optically connected to upstream and downstream fiber segments 32a, 32b by splices or by demateable connection interfaces that can include fiber optic connectors that may be coupled together by fiber optic adapters. In the depicted configuration, the upstream and downstream fiber segments 32a, 32b can each service sixteen subscribers and the subscriber access locations 24 can be adapted to provide sixteen connection locations (e.g., access ports) along each of the upstream and downstream fiber segments 32a, 32b. In one example, four subscriber access locations 24 are provided along each of the upstream and downstream fiber segments 32a, 32b with each of the subscriber access locations 24 providing connection access to four of the upstream or downstream segments 32a, 32b. In another example, eight fiber access locations 24 are provided along each of the segments 32a, 32b with each fiber access location 24 providing access to two fiber segments. In certain examples, the subscriber access locations 24 can include environmentally sealed enclosures/housings. In certain example, the enclosures can enclose splice trays or other splicing structures for allowing the drop cables 28 corresponding to the subscriber locations 26 to be optically spliced (e.g., fusion spliced or mechanically spliced) to the upstream and downstream fiber segments 32a, 32b at the subscriber access locations. In other examples, the subscriber access locations 24 include demateable fiber optic connection locations (e.g., connection locations including a fiber optic adapter (e.g., hardened or non-hardened) for coupling together two fiber optic connectors) wherein connectorized drop cables from the subscriber location can be plugged into ports 25 corresponding to the subscriber access locations 24 in a plug-and-play manner.

In other examples, at least some of the splitter outputs can be routed to subscriber access locations (e.g., ports, splice locations, etc.) located at the fiber distribution hubs such that the fiber distribution hubs can also function as subscriber access locations. It will be appreciated the fiber count of the fiber optic cable 20 and the split ratio of the passive optical power splitters can be varied from the specific configurations described above. In certain examples, the split ratio of the passive optical power splitters 36 can be more or less than 32 and the fiber count of the fiber optic cable 20 can be more or less than 24. In certain examples, the fiber optic cable 20 includes no more than 24 optical fibers, or includes no more than 36 optical fibers, or includes no more than 48 optical fibers.

The fiber optic cable 20 can have different configurations such as an elongate (e.g., “flat”) or round cross-sectional shape. Additionally, enclosures for the subscriber access locations can have a variety of configurations such as dome-style enclosures, cabinet style enclosures, box-style enclosures, or other styles of enclosures. The enclosures can be re-enterable in the field or non-re-enterable. An example non-re-enterable enclosure may include outside accessible hardened ports for connecting subscriber drop cables to the network. The enclosures can include cable pass-through functionality and can be adapted to mount over and seal mid-span locations of the fiber optic cable 20.

Example hardened (e.g., ruggedized) and non-hardened demateable connectorized optical connection interfaces including fiber optic adapters and fiber optic connectors are disclosed by U.S. Pat. No. 7,744,288 which is hereby incorporated by reference in its entirety. Example indexing patterns and systems using hardened multi-fiber connectors are disclosed by U.S. Pat. No. 10,788,629 which is hereby incorporated by reference in its entirety.

Aspects of the present disclosure also relate to optical components that can be connected together to efficiently and cost effectively build fiber optic architectures in accordance with the principles of the present disclosure. In certain examples, such optical components can be pre-built in a factory (e.g., substantial amounts of optical splicing can be pre-completed in the factory) thereby reducing the amount of labor (e.g., splicing labor) required in the field to install the fiber optic architecture. In certain examples, the optical components can include telecommunication housings (e.g., enclosures or closures that are preferably environmentally scaled and that can be re-enterable in some examples and non-re-enterable in other examples). In certain examples, first and second stub fiber optical cable can extend from the housing and can having optical fibers optically coupled within the housing (e.g., the optical coupling can occur in the factory). In certain examples, free ends of the first and/or second stub optical cable can be splice ready or alternatively can be connectorized (e.g., with non-hardened or hardened single fiber or multi-fiber connectors capable of providing de-mateable connections (e.g., plug-and-play connections)). In certain examples housing ends of the first and/or second stub optical fiber cables can pass through a seal (e.g., a gasket, a gel block, a gel block that can be pressurized by an actuator, sealant (e.g., rubber or gel) defining one or more ports for receiving cables and allowing cable to enter a housing in a sealed manner) when entering the housing and optical fibers of the stub optical fiber cables can be optically connected within the housing. In certain examples, the first and/or second stub optical fibers can have housing ends that are connectorized within non-hardened connectors (e.g., that are located inside the housing) or hardened connectors (e.g., hardened multi-fiber connectors) that plug into hardened ports on the housing or on short stubs that project from the housing.

In certain examples, the first and/or second stub optical cables can have constructions adapted to facilitate the identification of optical fibers in the field; and can have constructions for separating sets of fibers from each other. In certain examples, the stub optical fibers can each have a plurality of buffer tubes each containing a plurality of optical fibers and each having an identifier (e.g., a unique identifier) such that the buffer tubes can be separately identified. Examples of identifiers include color coding, numbering, marking with symbols or other marking. The optical fibers within each buffer tube can also include identifiers. The optical fibers within the buffer tubes can have a loose configuration or a ribbonized configuration (e.g., standard ribbon or rollable ribbon). The optical fibers in the buffer tubes can have an identifiable sequence which can be identified via ribbonization and/or via the identifiers (e.g., a first color can represent a first fiber in the sequence, a second color can represent a second fiber in the sequence, a third color can represent a third fiber in the sequence and so on through 8, 10, 12 or more optical fibers). One of the buffer tubes can contain and serve to identify feed optical fibers and the others of the buffer tubes can contain and serve to identify distribution fibers. Within the housing, one of the feed optical fibers of the first stub optical cable can be optically coupled (e.g., by an optical splice or by a demateable connectorized connection (e.g., a plug-and-play connection) to an input of a passive optical power splitter within the housing; others of the feed optical fibers of the first stub optical cable can be optically coupled to feed optical fibers of the second stub optical cable; and distribution fibers of the first and second stub optical cables can be optically coupled to outputs of the passive optical power splitter. In certain examples, the passive optical power splitter has a split ratio of at least 16, or least 24 or at least 32. In certain examples, the feed optical fibers are of the first and second stub optical cables are connected in an indexed configuration such that when a plurality of the fiber optic components are optically coupled together (e.g., daisy chained together) in the field to deploy an architecture in accordance with the principles of the present disclosure the fiber optic components provide a built-in autofeed function that ensures that a predetermined feed fiber of the feed fiber sequence of fibers is provided at each consecutive housing in the chain of fiber optic components.

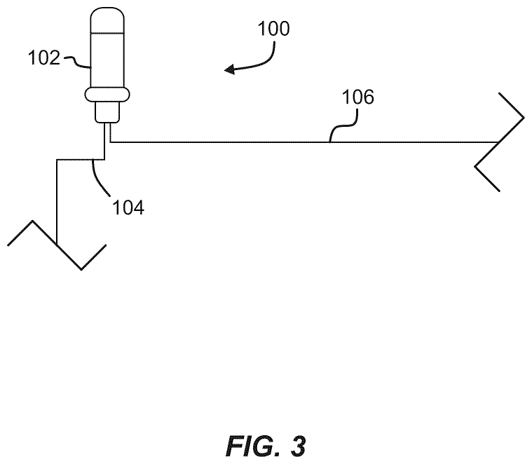

FIG. 3 depicts a fiber optic component 100 in accordance with the principles of the present disclosure that can be used as a building-block to deploy a fiber optic architecture in accordance with the principles of the present disclosure. The fiber optic component 100 includes a housing 102 and first and second stub fiber optic cables 104, 106 that extend from the housing 102. The housing 102 can be environmentally sealed and can include sealed openings through which the first and second stub fiber optic cables 104, 106 extend to access an interior of the housing 102. The housing can include sealant (e.g., gel, rubber, or other sealant) defining ports through which the first and second stub fiber optic cables can extend in a sealed manner (e.g., the sealant seals about outer jackets of the first and second stub fiber optic cables 104, 106. In one example, the first and second stub fiber optic cables 104, 106 can each have the same cross-sectional configuration and the same fiber count. In one example, free ends of the first and second stub fiber optic cables 104, 106 can be splice ready. In one example, the first stub fiber optic cable 104 is substantially shorter than the second stub fiber optic cable 106. For example, the second stub fiber optic cable 106 can be at least 10, 20, or 40 times as long as the first stub fiber optic cable 104. In one example, the first stub fiber optic cable 104 has a length that is less than or equal to 200 feet or less than or equal to 100 feet. In one example, the second stub fiber optic cable 106 has a length that is greater than or equal to 1000 feet or greater than or equal to 2000 feet. In one example, the length of the second stub fiber optic cable 106 is in the range of 2000-20000 feet. In one example, the housing can include a cover that mounts to a removeable base containing a sealant that can be pressurized with an actuator. The stub cables can be routed thought ports in the sealant and the sealant can be pressurized about the stub cables to seal about the outer profiles of the cable jackets of the stub cables. The housing can be re-entered in the field by removing the cover (e.g., a dome-style cover) from the base. Other types of housings can be used as well.

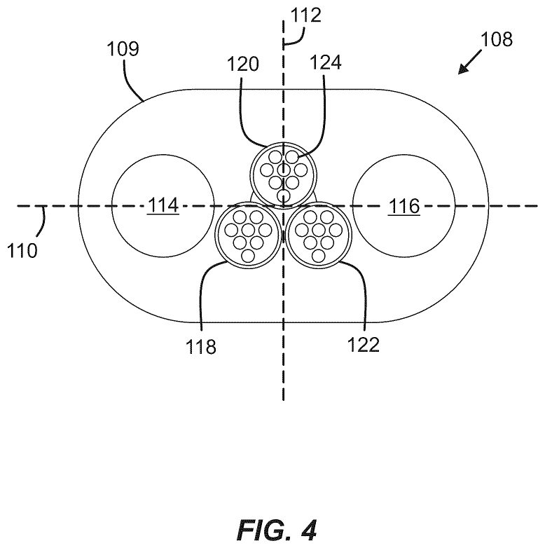

FIG. 4 is a transverse cross-sectional view showing a design of a fiber optic cable 108 suitable for use as first and second stub fiber optic cables 104, 106. The fiber optic cable 108 has a flat-drop design including an outer jacket 109 having elongate cross-sectional shape/profile which is longer along a cross-section major axis 110 as compared to along a cross-section minor axis 112. First and second strength members 114, 116 (e.g., rods such as fiberglass reinforced polymer rods or other members) are centered along the cross-section major axis 110 (e.g., bisected by the major axis 110). A plurality of buffer tubes is positioned between the first and second strength members 114, 116. As depicted, the buffer tubes include first, second and third buffer tubes 118, 120 and 122 arranged in a triangular configuration when viewed in cross-section. The first, second and third buffer tubes 118, 120 and 122 are not aligned/centered along the cross-section major axis 110. Instead, when the cable is viewed in cross-section, at least some of the buffer tubes have major portions positioned on opposite sides of the major axis 110. In certain examples, the first, second and third buffer tubes 118, 120 and 122 are stranded together to form a stranded (e.g., twisted) core. In certain examples, the fiber optic cable 108 has a similar outer jacket profile as standard drop cable and can be used with existing jacket stripping and cable clamping equipment. In certain examples, the first, second and third buffer tubes 118, 120, 122 can each have separate indicia and can each contain a plurality of optical fibers 124. The optical fibers 124 within each of the buffer tubes 118, 120 and 122 can have separate indicia to be separately identifiable within each buffer tube 118, 120 and 122. The buffer tubes 118, 120 and 122 can separate the optical fibers 124 based on functionality. For example, the buffer tube 118 can contain optical fibers that function as feeder fibers and the buffer tubes 120, 122 can contain optical fibers that function as distribution fibers. As depicted, each of the buffer tubes 118, 120 and 122 contains eight of the optical fibers 124 with the buffer tubes 118, 120, 122 being color coded and the optical fibers 124 within the buffer tubes 118, 120 and 122 being color coded.

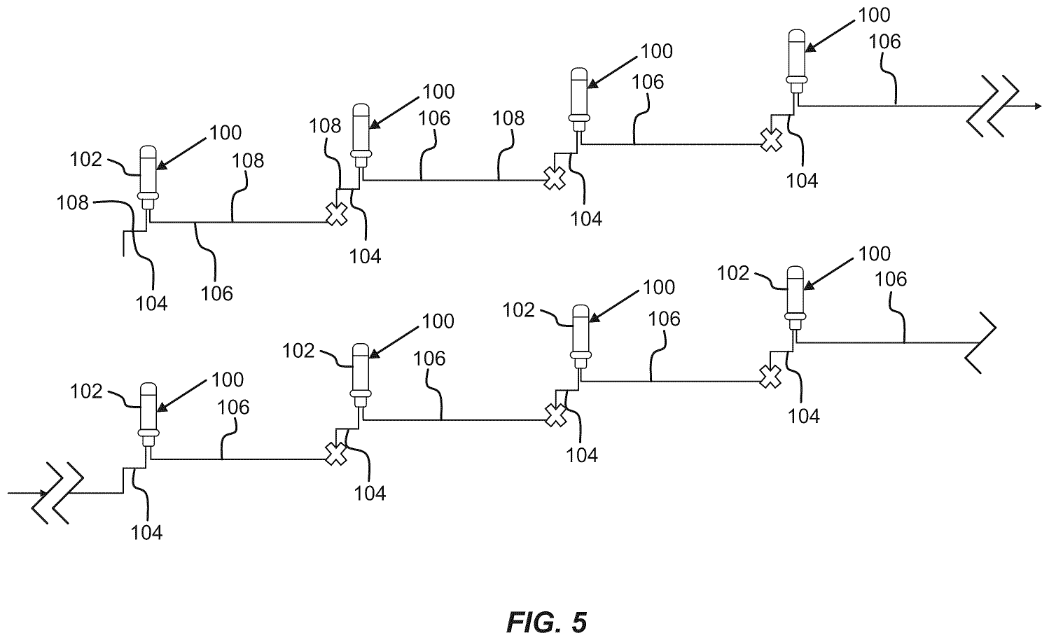

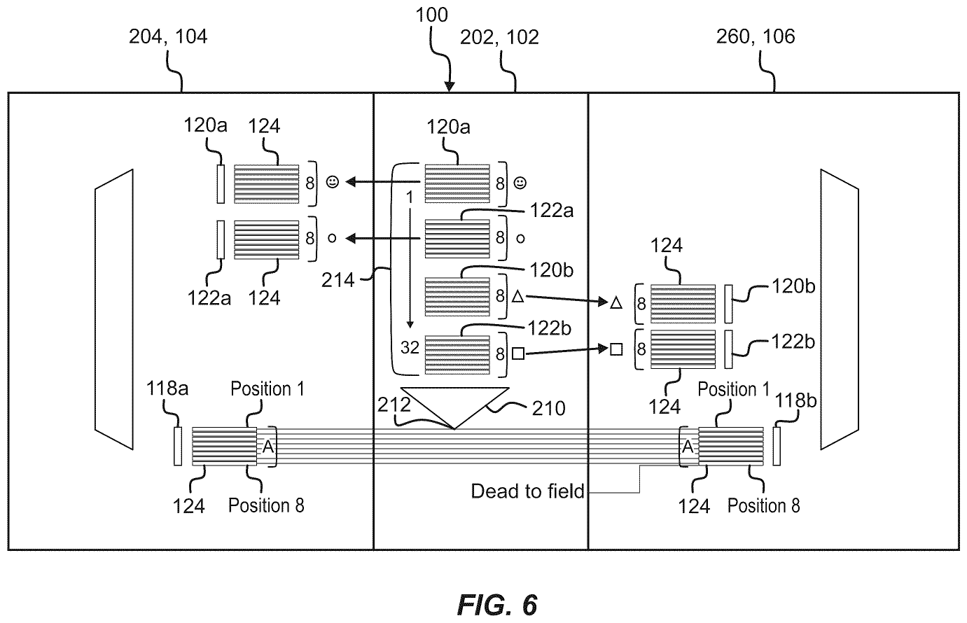

FIG. 5 depicts a plurality of the fiber optic components 100 daisy chained together to form an architecture in accordance with the principles of the present disclosure. As depicted, the first stub fiber optic cable 104 of the first fiber optic component 100 in the chain can be optically connected (e.g., spliced) to a fiber optic cable connected to a feed structure (e.g., an Optical Line Terminal that may be at a central office). The second stub fiber optic cable 106 of the first fiber optic component 100 in the chain is shown optically connected to the first stub fiber optic cable 104 of the second fiber optic component 100 in the chain. It will be appreciated that this pattern can be repeated throughout the length of the chain with the first stub fiber optic cable 104 of each fiber optic component being optically connected to the second stub fiber optic cable 106 of an immediately preceding fiber optic component 100 and the second stub optical cable 106 of each fiber optic component 100 connected to the first stub fiber optic cable 104 of an immediately following fiber optic component 100. Access points can be cut into the second stub fiber optic cables 106 at locations between the housings to provide drop locations to subscriber locations. Housings can be mounted over the second stub fiber optic cables 106 at the drop locations and the optical fibers 124 within the second and third buffer tubes 120, 122 can be accessed at the drop locations. The feeder fibers in the first buffer tubes 118 of the second stub fiber optic cables would preferably not be accessed at the drop locations (e.g., the buffer tubes 118 would pass through the drop locations without being accessed). At FIGS. 5, 8 and 11, the x's represent splice locations. During splicing, like identified optical fibers of the buffer tubes of the stub cables 104, 106 being connected together are optically connected (e.g., spliced) to each other. So, at the free ends of the stub cables 104, 106, like-identified optical fibers of the buffer tubes 118a. 118b (see FIG. 6) (e.g., fibers having the same indicia) are optically connected together, like-identified optical fibers of the buffer tubes 120a. 120b (see FIG. 6) (e.g., fibers having the same indicia) are optically connected together, and like-identified optical fibers of the buffer tubes 122a, 122b (see FIG. 6) (e.g., fibers having the same indicia) are optically connected together.

FIG. 6 is a schematic depiction of one of the fiber optic components 100 where box 202 represents the housing 102 and related components, box 204 represents the first stub optical cable 104 and box 206 represents the second stub optical cable 106. The first buffer tubes 118 (containing the feeder fibers) of the first and second stub optical cables 104, 106 are respectively indicated as buffer tube 118a for the first stub optical cable 104 and buffer tube 118b for the second stub optical cable 106. The second and third buffer tubes 120, 122 (containing the distribution fibers) of the first and second stub optical cables 104, 106 are respectively indicated as buffer tubes 120a. 122a for the first stub optical cable 104 and buffer tubes 120b, 122b for the second stub optical cable 106. The optical fibers 124 of the buffer tubes 118a. 118b are depicted arranged in a sequence of eight fibers in a row of positions ordered from position 1 to position 8 from top to bottom. The fiber optic component 20 includes a passive optical power splitter 210 depicted as having a split ratio of 1:32. The optical fiber 124 at the first position of the buffer tube 118a is not passed through to the second stub optical cable 106 and instead is optically coupled to an input 212 of the passive optical power splitter 210. The optical fibers 124 at positions 2-8 of the buffer tube 118a are respectively optically coupled to the optical fibers 124 at positions 1-7 of the buffer tube 118b. This type of configuration is one example of an indexed optical coupling configuration between the optical fibers 124 of the buffer tube 118a and the optical fibers 124 of the buffer tube 118b. The optical fibers 124 of the second and third buffer tubes 120a, 122a as well as the optical fibers 124 of the buffer tubes 120b, 122b are optically coupled to an output side 214 (i.e., to optical outputs carrying signals that have been power split by the passive optical power splitter) of the passive optical power splitter 210. In one example, a dead fiber (e.g., the fiber corresponding to fiber position 8 of the buffer tube 118b) and the dropped fiber for the buffer tube 118a (e.g., the fiber corresponding to fiber position 1 of the buffer tube 118a) can be routed to the input of an optical coupler (e.g., a 2×1 coupler) and the output of the coupler can be coupled to the input of the optical power splitter 210 to provide redundant signal paths for supplying feed fiber input to the splitter 210.

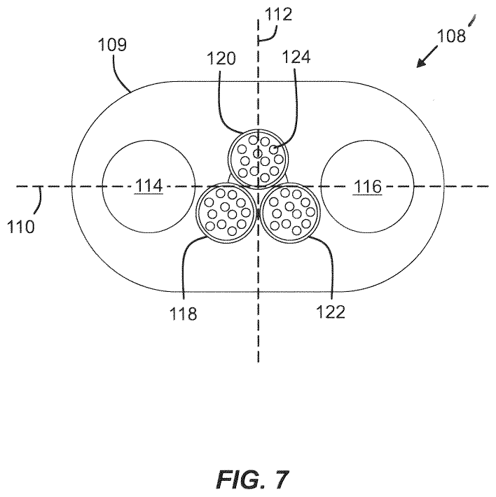

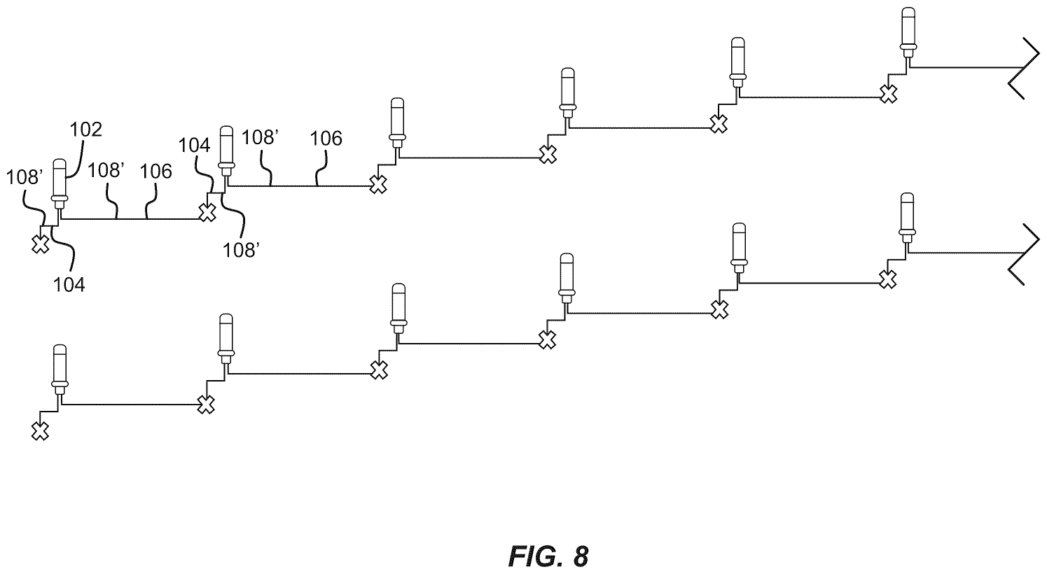

FIG. 7 is a transverse cross-sectional view showing another design of a fiber optic cable 108′ suitable for use as first and second stub fiber optic cables 104, 106. The cable 108′ has the same configuration as the cable 108 except twelve optical fibers are provided in each of the buffer tubes 118, 120, 122. The four extra feed fibers in the first buffer tubes 118 allow for the network architecture to be extended further to more subscribers (e.g., see FIG. 8) as compared to when only eight feed fibers (see FIG. 5). When used with optical components having passive optical splitters with a split ratio of 1:32, the second and third buffer tubes 120, 122 of the stub fiber optic cables 104, 106 are each provided with 4 spare fibers that could be used for future expansion or repair.

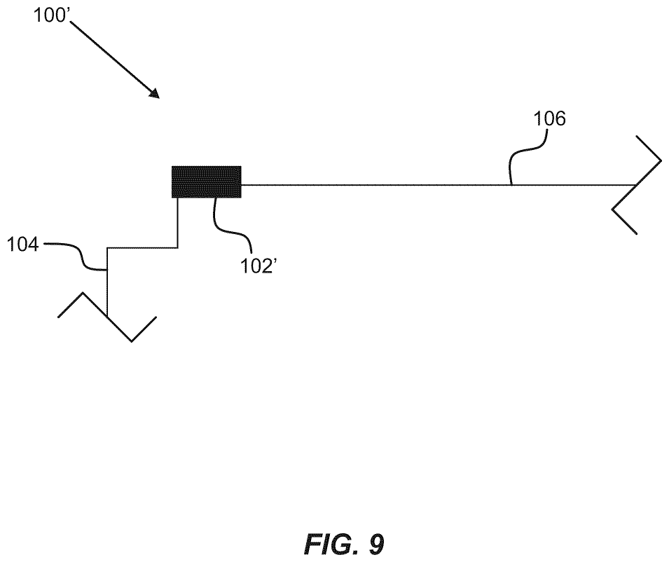

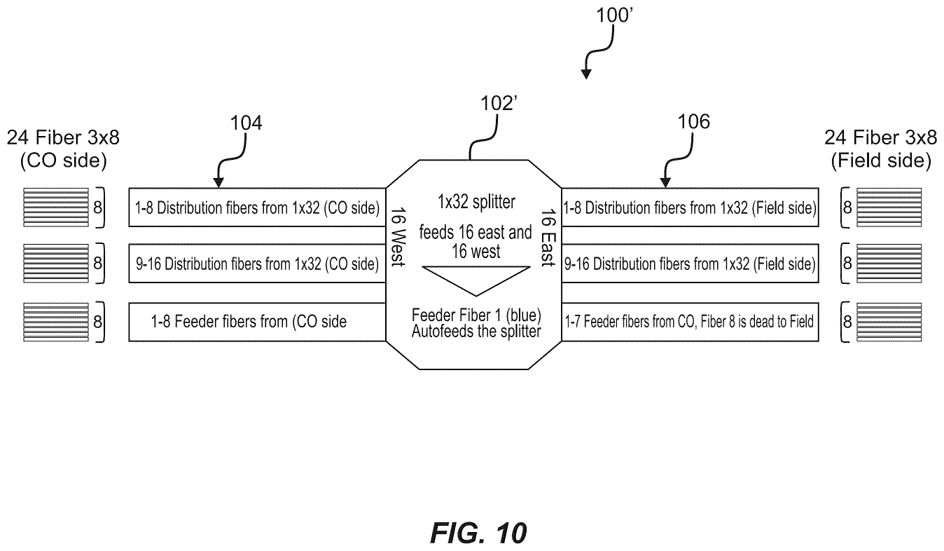

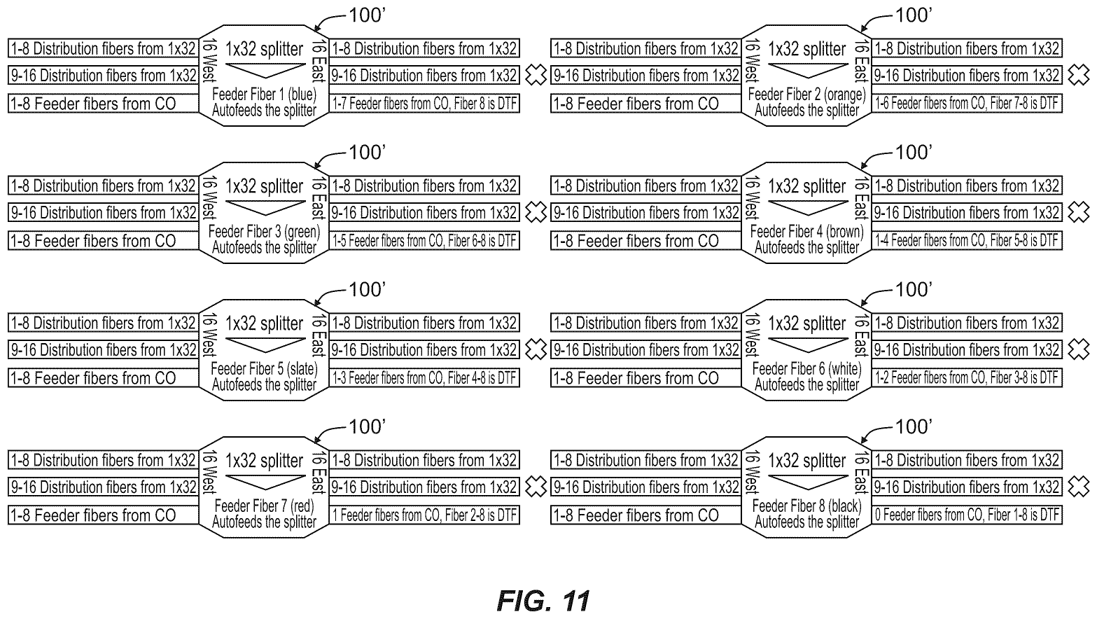

FIGS. 9 and 10 depict another optical component 100′ in accordance with the principles of the present disclosure that can be used as a building-block to deploy a fiber optic architecture in accordance with the principles of the present disclosure. The fiber optic component 100′ includes a housing 102′ and first and second stub fiber optic cables 104, 106 that extend from the housing 102′. The housing 102′ is preferably a factory sealed terminal that is not designed to be opened in the field. The internal fiber routing within the housing 102′ can be completed in the factory before sealing of the housing 102′ and can have a configuration that matches the arrangement of FIG. 6. FIG. 11 depicts a plurality of the optical components 100′ daisy-chained together to form an architecture in accordance with the principles of the present disclosure.

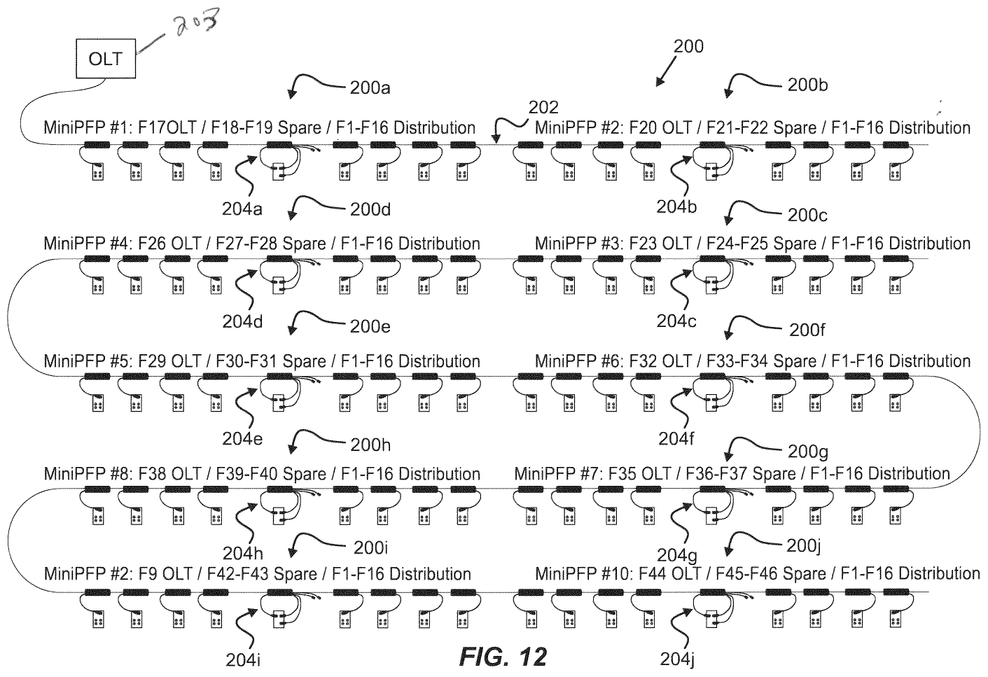

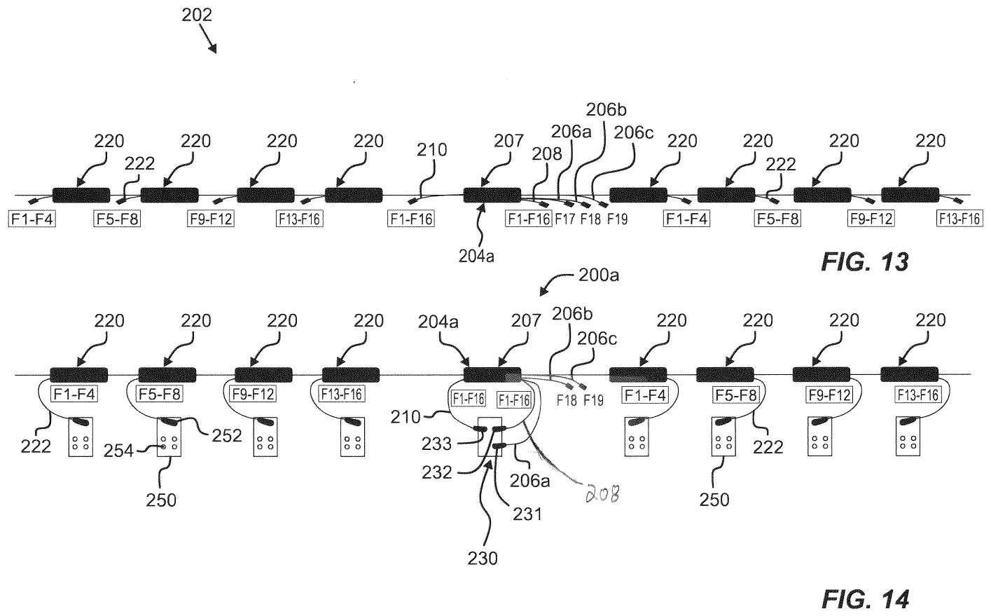

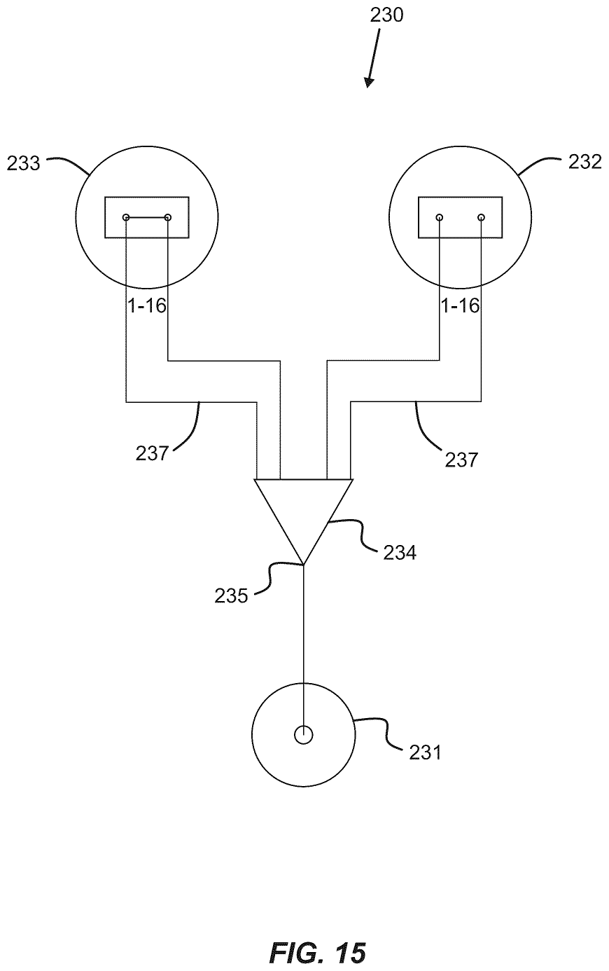

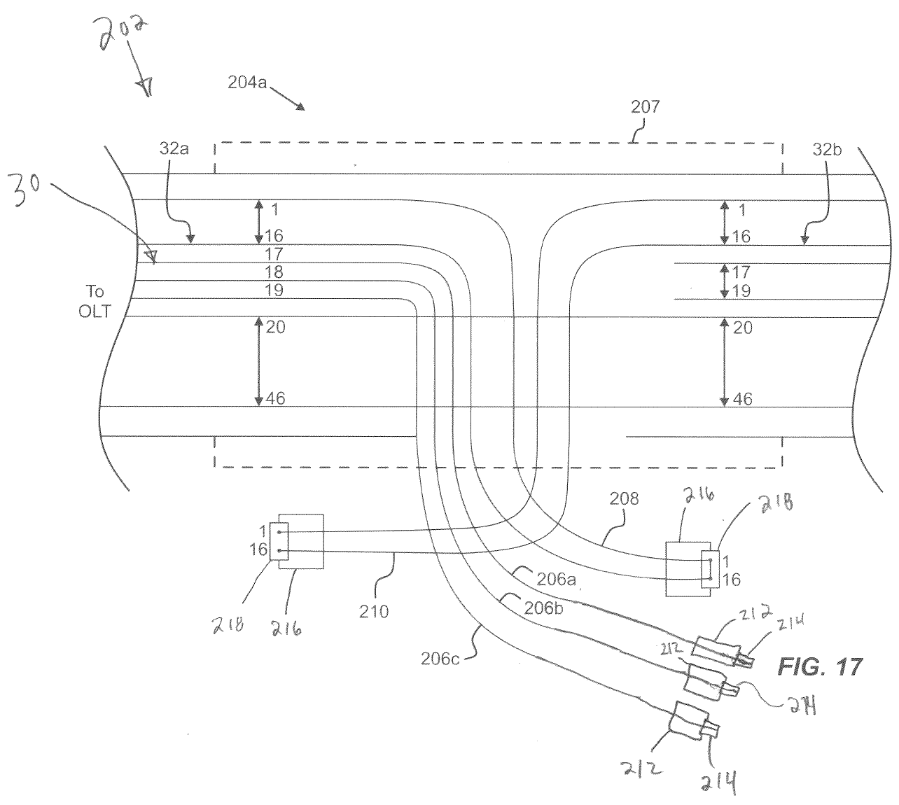

FIGS. 12 and 14 depict a plug-and-play network architecture 200 in accordance with the principles of the present disclosure having an assembly that includes a fiber optic cable 202 (see FIG. 13) with factory installed break-out locations. The network architecture 200 includes a plurality of fiber distribution zones (e.g., regions) 200a-200j positioned along consecutive spans (e.g., lengths) of the fiber optic cable 202. As depicted, the fiber optic cable 202 connects to a signal source 203 such as an OLT with fiber distribution zone 200a closest to the signal source 203 and fiber distribution zone 200j furthest from the signal source 203. The fiber optic cable 200 includes a jacket containing feed fibers and distribution fibers and can have a construction of the type shown and described above with respect to FIGS. 4 and 7. A plurality of hub break-out locations 204a-204j are spaced-apart along a length of the fiber optic cable 200 and positioned at mid-span locations of the fiber optic cable 200. As depicted, the hub break-out locations 204a-204j are located at central locations of each of the fiber distribution zones 200a-200j, respectively. Each of the hub-break-out locations 204a-204j can include a plurality of fiber optic tethers (e.g., fiber optic stubs) which may include a feed tether 206, a first multi-fiber tether 208 and a second multi-fiber tether 210. As depicted, each hub-break-out location 204a-204j includes three feed tethers 206a-c with one of the feed tethers 206a-c being used initially to connect a feed fiber to the architecture and the others of the feed tethers 206a-c providing network access to spare feed fibers available for future use in the architecture and/or back-up. Each of the tethers can be anchored to the main body of the cable 202 at one of the breakout locations, and can include a jacket containing a strength member and one or more optical fibers. The tethers can include free ends at which fiber optic connectors are attached (i.e., the tethers can have connectorized free ends). As shown at FIG. 17, The connectors can include single fiber optical connectors 212 having ferrules 214 (e.g., SC or LC ferrules) each supporting one optical fiber or multi-fiber optical connectors 216 having ferrules 218 (e.g., MPO ferrules) each supporting a plurality of optical fibers. Each of the hub break-out locations 204a-204j can be sealed and protected by a protective layer 207 (e.g., a heat shrink; an overmold; etc.) that can be installed at the factory/cable manufacturing facility. The connectors 212, 216 can be hardened/ruggedized for outdoor use.

Referring still to FIG. 17, one example of the cable 202 is depicted that includes forty-six optical fibers with fibers one through sixteen being distribution fibers 32 and fibers seventeen through forty-six being feed fibers 30. At each of the hub break-out locations 204a-204j the distribution fibers 32 are divided into pairs of upstream and downstream fiber segments 32a, 32b with the upstream fiber segments 32a corresponding to portions of the fiber distribution zones 200a-200j located upstream of the corresponding hub break-out locations 204a-204j and the downstream fiber segments 32b corresponding to portions of the fiber distribution zones 200a-200j located downstream of the corresponding hub break-out locations 204a-204j. Fibers of the feed tethers 206a-c are optically coupled (e.g., spliced such as by an optical spice made at the factory/manufacturing facility) to selected ones of the feed fibers 30. The feed fibers 30 are progressively coupled to the feed tethers 206a-c of the hub break-out locations 204a-204j. For example, as shown at FIG. 17, at the hub break-out location 204a fibers seventeen through nineteen of the feed fibers 30 are respectively optically coupled to fibers of the feed tethers 206a-c. In a similar way, the feed tethers 206a-c of the hub break-out location 204b are respectively optically couped to fibers twenty through twenty-two of the feed fibers 30; the feed tethers 206a-c of the hub break-out location 204c are respectively optically couped to fibers twenty-three through twenty-five of the feed fibers 30; the feed tethers 206a-c of the hub break-out location 204d are respectively optically couped to fibers twenty-six through twenty-eight of the feed fibers 30; the feed tethers 206a-c of the hub break-out location 204e are respectively optically couped to fibers twenty-nine through thirty-one of the feed fibers 30; the feed tethers 206a-c of the hub break-out location 204f are respectively optically couped to fibers thirty-two through thirty-four of the feed fibers 30; the feed tethers 206a-c of the hub break-out location 204g are respectively optically couped to fibers thirty-five through thirty-seven of the feed fibers 30; the feed tethers 206a-c of the hub break-out location 204h are respectively optically couped to fibers thirty-eight through forty of the feed fibers 30; the feed tethers 206a-c of the hub break-out location 204i are respectively optically couped to fibers forty-one through forty-three of the feed fibers 30; and the feed tethers 206a-c of the hub break-out location 204j are respectively optically couped to fibers forty-four through forty-six of the feed fibers 30.

At each of the hub break-out locations 204a-204j, the optical fibers of the first multi-fiber tether 208 optically connect to the corresponding upstream fiber segments 32a and the optical fibers of the second multi-fiber tether 210 optically connect to the corresponding downstream fiber segments 32. The optical connections can be optical splices such as optical splices (e.g., fusion splices) made at the cable manufacturing facility.

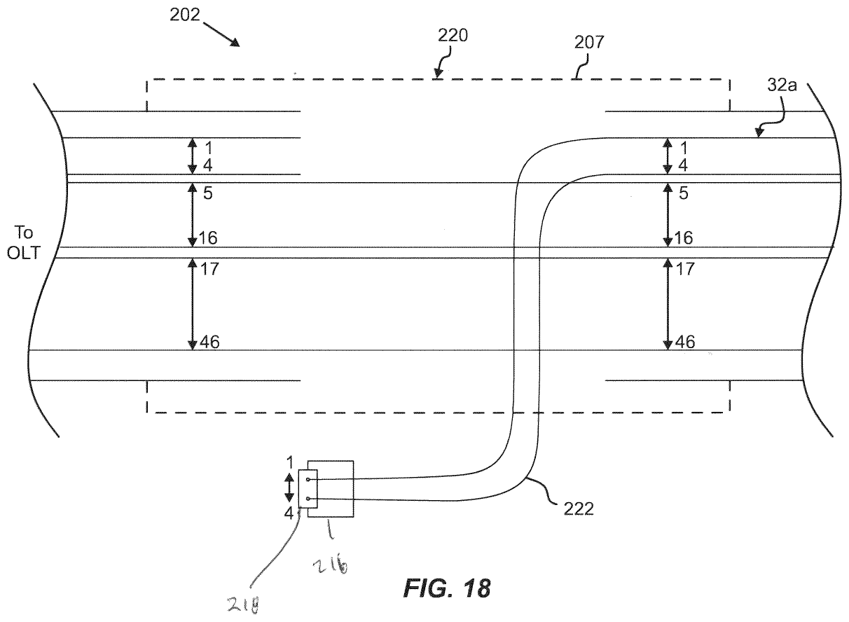

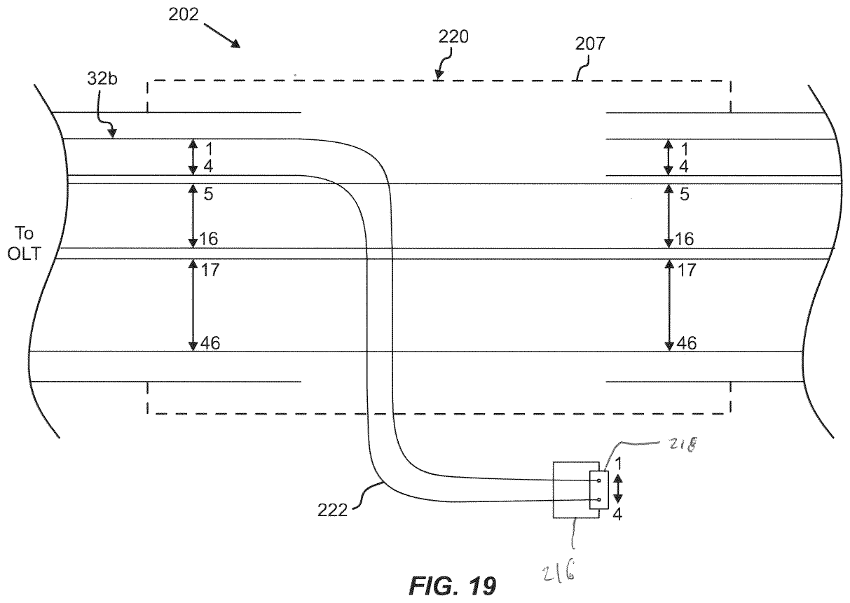

The fiber optic cable 202 also includes subscriber access break-out locations 220 positioned at second mid-span locations of the fiber optic cable 202 spaced along the upstream and downstream fiber segments 32a, 32b at each of the fiber distribution zones 200a-200j. The subscriber access break-out locations 220 along the upstream fiber segments 32a have multi-fiber distribution tethers 222 including optical fibers that optically connect to the at least some of the upstream fiber segments 32a (see FIG. 18) and the subscriber access break-out locations 220 along the downstream fiber segments 32b have multi-fiber distribution tethers 222 including optical fibers that optically connect to at least some of the downstream fiber segments 32b (see FIG. 19). The multi-fiber distribution tethers 222 can have having connectorized ends terminated by multi-fiber connectors 216. Protective layers 207 can protect the subscriber access break-out locations 220. In the depicted example, four subscriber access break-out locations 220 are provided along each set of the upstream and downstream fiber segments 32a, 32a. In one example, four of the optical fibers of the upstream and downstream fiber segments 32a, 32a are accessed at each of the subscriber access break-out locations 220. Different fibers (e.g., a different set of 4 fibers) of the upstream and downstream fiber segments 32a, 32b are accessed at each of the subscriber access break-out locations 220 for each set of upstream and downstream fiber segments 32a, 32b. For example, for each set of upstream fiber segments 32a a first subscriber access break-out location 220 will access fibers 1-4, a second subscriber access break-out location 220 will access fibers 5-8, a third subscriber access break-out location 220 will access fibers 9-12 and a fourth subscriber access break-out location 220 will access fibers 13-16. Similarly, for each set of downstream fiber segments 32b a first subscriber access break-out location 220 will access fibers 1-4, a second subscriber access break-out location 220 will access fibers 5-8, a third subscriber access break-out location 220 will access fibers 9-12 and a fourth subscriber access break-out location 220 will access fibers 13-16.

The architecture 200 is deployed in the field by deploying the fiber optic cable 202 and then connecting the breakout locations of the cables to terminals (e.g., by connectorized demateable connections to allow for plug-and-play deployment of the terminals). The terminals can include hub terminals 230 (see FIG. 14) installed each of the hub break-out locations 204a-204j and distribution terminals 250 (see FIG. 14) installed at each of the subscriber access break-out locations 220.

Referring to FIG. 15, each of the hub terminals 230 has an input port 231 and first and second multi-fiber output ports 232, 233. The ports 231-233 can be fiber optic adapter ports such as hardened fiber optic adapter ports. The hub terminals 230 also can include passive optical power splitters 234 having a fiber input 235 optically connected to the input port 236 and outputs 237 optically connected to the first and second multi-fiber output ports 232, 233. The hub terminals 230 are installed at the hub break-out locations 204a-204j with the connectorized ends of the feed tethers 206a coupled with the input ports 231 and the connectorized ends of the first and second multi-fiber tethers 208, 210 coupled respectively with the first and second multi-fiber output ports 232, 233. In this way, a feed signal from a feed fiber is input from the feed tether 206a to the passive optical splitter 234 where the feed signal is split and directed to the upstream and downstream fiber segments 32a, 32b via the first and second multi-fiber output ports 232, 233 and the corresponding first and second multi-fiber tethers 208, 210.

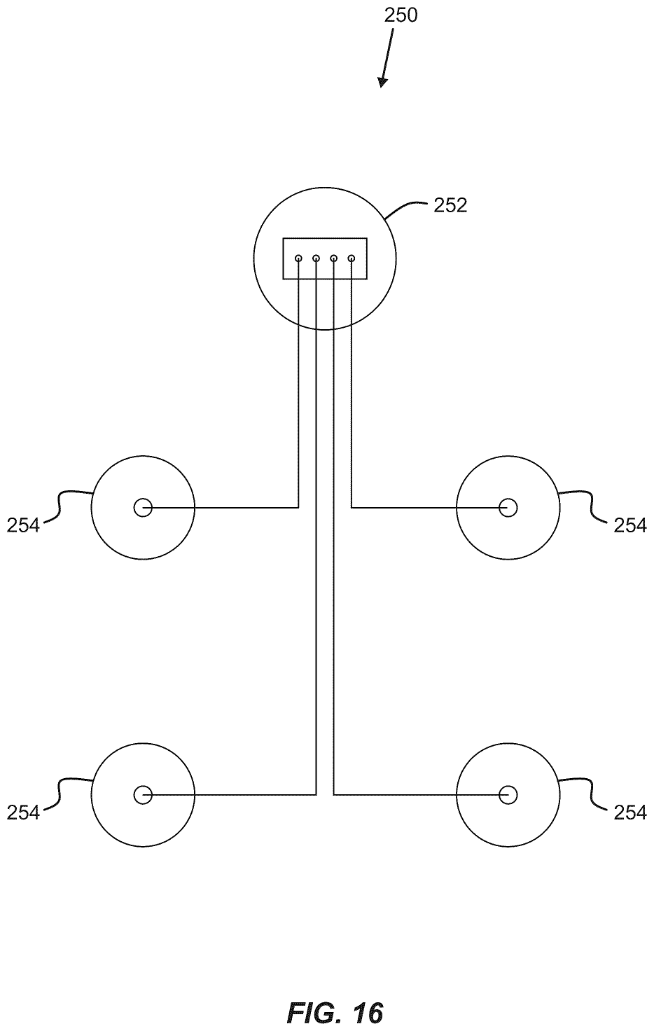

Referring to FIG. 16, the distribution terminals 250 each having a multi-fiber input port 252 and a plurality of single fiber distribution ports 254. The multi-fiber input ports 252 are optically coupled to the single fiber distribution ports 254. The distribution terminals 250 are installed at the subscriber access break-out locations 220 with the connectorized ends of the multi-fiber distribution tethers 222 coupled with the multi-fiber input ports 252. In this way, individual ones of the upstream and downstream fiber segments 32a, 32b of optically connected to each of the single fiber distribution ports 254. Subscribers can be connected to the network by plugging drop cables into the single fiber distribution ports 254. The ports 252, 254 can be fiber optic adapter ports such as hardened fiber optic adapter ports.

From the forgoing detailed description, it will be evident that modifications and variations can be made in the devices of the disclosure without departing from the spirit or scope of the invention.

What is claimed is:

1. A fiber optic architecture comprising:
a fiber optic cable including a first group of optical fibers including feed fibers and a second group of optical fiber including distribution fibers;
a plurality of passive optical power splitters spaced-apart along a length of the fiber optic cable and positioned at first mid-span locations of the fiber optic cable;
the feed fibers being optically coupled to inputs of the passive optical power splitters;
the distribution fibers being divided into pairs of upstream and downstream fiber segments with each pair of upstream and downstream fiber segments being optically coupled to outputs of one of the passive optical power splitters, wherein the upstream fiber segments extend through the fiber optic cable in an upstream direction from their corresponding passive optical power splitters and the downstream fiber segments extend through the fiber optic cable in a downstream direction from their corresponding passive optical power splitters; and
subscriber access locations positioned at second mid-span locations of the fiber optic cable spaced along the upstream and downstream fiber segments for allowing subscribers to be optically connected to the upstream and downstream fiber segments and thus optically connected to the fiber optic architecture.

2. The fiber optic architecture of claim 1, wherein the passive optical power splitter is a 1 by 32 splitter.

3. The fiber optic architecture of claim 1, wherein the passive optical power splitter has a split ratio of at least 1 by 32.

4. The fiber optic architecture of claim 1, wherein the fiber optic cable includes no more than 24 optical fibers.

5. The fiber optic architecture of claim 1, wherein the fiber optic cable includes no more than 36 optical fibers.

6. The fiber optic architecture of claim 1, wherein the fiber optic cable includes no more than 48 optical fibers.

7. The fiber optic architecture of claim 1, wherein the subscriber access locations include environmentally sealed enclosures through which the fiber optic cable is routed.

8. The fiber optic architecture of claim 1, wherein drop cables corresponding to the subscriber locations are optically spliced to the upstream and downstream fiber segments at the subscriber access locations.

9. The fiber optic architecture of claim 1, wherein drop cables corresponding to the subscriber locations are optically coupled to the upstream and downstream fiber segments at the subscriber access locations by demateable connectorized optical connections.

10. The fiber optic architecture of claim 9, wherein each demateable connectorized optical connection includes a fiber optic adapter for coupling together two fiber optic connectors.

11. The fiber optic architecture of claim 10, wherein the fiber optic adapter is hardened or non-hardened.

12. A fiber optic component comprising:
a housing;
a passive optical power splitter positioned within the housing, the passive optical power splitter including an optical input and a plurality of optical outputs optically coupled to the input; and
a first stub fiber optic cable that extends outwardly from the housing, the first stub fiber optic cable including a feed optical fiber and a plurality of distribution optical fibers, the feed optical fiber being optically coupled to the optical input of the passive optical power splitter and the distribution optical fibers being optically coupled to the plurality of optical outputs of the passive optical power splitter.

13. The fiber optic component of claim 12, wherein the feed optical fiber is optically spliced to the optical input of the passive optical power splitter and the distribution optical fibers are optically spliced to the plurality of optical outputs of the passive optical power splitter.

14. The fiber optic component of claim 13, wherein the first stub fiber optic cable is routed into the housing through a seal.

15. The fiber optic component of claim 12, wherein the feed optical fiber is factory optically spliced to the optical input of the passive optical power splitter and the distribution optical fibers are factory optically spliced to the plurality of optical outputs of the passive optical power splitter.

16. The fiber optic component of claim 12, wherein the first stub fiber optic cable includes a cable jacket containing at least one strength member, a first buffer tube including a first indicia and second buffer tube having a second indicia different from the first indicia, wherein the feed optical fiber is contained in the first buffer tube and the distribution optical fibers are contained in the second buffer tube.

17. The fiber optic component of claim 16, wherein the feed optic fiber is one of a plurality of feed optical fibers contained in the first buffer tube.

18. The fiber optic component of claim 17, wherein the first stub fiber optic cable includes a third buffer tube contained in the cable jacket, wherein the plurality of distribution optical fibers include a first plurality of distribution optical fibers contained in the second buffer tube and a second plurality of distribution optical fibers contained in the third buffer tube.

19. The fiber optic component of claim 18, wherein the plurality of feed optical fibers includes 12 of the feed optical fibers, wherein the first plurality of distribution optical fibers includes 12 of the distribution optical fibers, and wherein the second plurality of distribution optical fibers incudes 12 of the distribution optical fibers.

20. The fiber optic component of claim 12, further comprising a second stub fiber optic cable that extends outwardly from the housing, the second stub fiber optic cable including a plurality of feed optical fibers and a plurality of distribution optical fibers, the plurality of distribution optical fibers of the second stub fiber optic cable being optically connected to the plurality of optical outputs of the passive optical power splitter.

21. The fiber optic component of claim 20, wherein the first stub fiber optic cable and the second stub fiber optic cable have the same construction.

22. The fiber optic component of claim 20, wherein the feed optical fiber of the first stub fiber optic cable that is optically coupled to the optical input of the passive optical power splitter is a first feed optical fiber, and wherein second feed optical fibers of the first stub fiber optic cable are coupled to the feed optical fibers of the second stub fiber optic cable in an indexed manner.

23. The fiber optic component of claim 20, wherein the feed optical fibers of the first stub fiber optic cable and the feed optical fibers of the second fiber optic cable each have a matching identifiable sequence, wherein the feed optical fiber of the first stub fiber optic cable that is optically coupled to the optical input of the passive optical power splitter is a first feed optical fiber, and wherein second feed optical fibers of the first stub fiber optic cable are coupled to the feed optical fibers of the second stub fiber optic cable in an indexed manner such that the second feed optical fibers of the first stub fiber optic cable have different positions in the identifiable sequence than the feed optical fibers of the second stub fiber optic cable to which they are respectively optically coupled.

24. The fiber optic component of claim 23, wherein the feed optical fibers have visual identifiers for identifying specific ones of the feed optical fibers of within the identifiable sequence.

25. The fiber optic component of claim 20, wherein the second stub fiber optic cable is at least 10 times longer than the first stub fiber optic cable.

26. A fiber optic architecture comprising:
a fiber optic cable including feed fibers and distribution fibers;
a plurality of passive optical power splitters spaced-apart along a length of the fiber optic cable and positioned at first mid-span locations of the fiber optic cable;
the feed fibers being optically coupled to inputs of the passive optical power splitters;
the distribution fibers being divided into pairs of upstream and downstream fiber segments with each pair of upstream and downstream fiber segments being optically coupled to an output of one of the passive optical power splitters, wherein the upstream fiber segments extend through the fiber optic cable in an upstream direction from their corresponding passive optical power splitters and the downstream fiber segments extend through the fiber optic cable in a downstream direction from their corresponding passive optical power splitters; and
subscriber access locations positioned at second mid-span locations of the fiber optic cable spaced along the upstream and downstream fiber segments for allowing subscribers to be optically connected to the upstream and downstream fiber segments and thus optically connected to the fiber optic architecture.

27. An assembly comprising:
a fiber optic cable including a jacket containing feed fibers and distribution fibers;
a plurality of hub break-out locations spaced-apart along a length of the fiber optic cable, the hub break-out locations each including a feed tether, a first multi-fiber tether and a second multi-fiber tether, the feed tether, the first multi-fiber tether and the second multi-fiber tether having connectorized ends;
the feed fibers being optically coupled to the feed tethers;
the distribution fibers being divided into pairs of upstream and downstream fiber segments with each pair of upstream and downstream fiber segments being respectively optically coupled to the first multi-fiber tether and the second multi-fiber tether of a corresponding one of the hub break-out locations, wherein the upstream fiber segments extend through the fiber optic cable in an upstream direction from their corresponding hub break-out locations and the downstream fiber segments extend through the fiber optic cable in a downstream direction from their corresponding hub break-out locations; and
subscriber access break-out locations spaced along the upstream and downstream fiber segments, the subscriber access break-out locations along the upstream fiber segments having multi-fiber distribution tethers that optically connect to at least some of the upstream fiber segments and the subscriber access break-out locations along the downstream fiber segments having multi-fiber distribution tethers that optically connect to at least some of the downstream fiber segments, the multi-fiber distribution tethers having connectorized ends.

28. The assembly of claim 27, further comprising hub terminals each having an input port and first and second multi-fiber output ports, the hub terminals also including passive optical power splitters having fiber inputs optically connected to the input ports and outputs optically connected to the first and second multi-fiber output ports, the hub terminals being installed at the hub break-out locations with the connectorized ends of the feed tethers coupled with the input ports and the connectorized ends of the first and second multi-fiber tethers coupled respectively with the first and second multi-fiber output ports.

29. The assembly of claim 28, further comprising distribution terminals each having a multi-fiber input port and a plurality of single fiber distribution ports, the multi-fiber input ports being optically coupled to the single fiber distribution ports, the distribution terminals being installed at the subscriber access break-out locations with the connectorized ends of the multi-fiber distribution tethers coupled with the multi-fiber input ports.
